(19) United States
(12) Patent Application Publication
(10) Pub. No.: US 2025/0170882 A1
(43) Pub. Date: May 29, 2025

(54) BATTERY PACK STRUCTURE

(71) Applicant: TOYOTA JIDOSHA KABUSHIKI KAISHA, Toyota-shi (JP)

(72) Inventors: Satoru ABE, Okazaki-shi (JP); YUZURU SHIOTA, Nagoya-shi (JP); Tetsuo NURUKI, Toyota-shi (JP); Seiji ARAKAWA, Nisshin-shi (JP); Kazusa ENDO, Toyota-shi (JP)

(73) Assignee: TOYOTA JIDOSHA KABUSHIKI KAISHA, Toyota-shi (JP)

(21) Appl. No.: 18/769,618

(22) Filed: Jul. 11, 2024

(30) Foreign Application Priority Data
Nov. 24, 2023 (JP) 2023-199426

(51) Int. Cl. B60K 1/04; B60L 50/64; H01M 50/209; H01M 50/242; H01M 50/249; H01M 50/262; H01M 50/271

(52) U.S. Cl. CPC B60K 1/04; B60L 50/64; H01M 50/209; H01M 50/242; H01M 50/249; H01M 50/262; H01M 50/271; B60K 2001/0438; H01M 2220/20

(57) ABSTRACT

In the battery case, the rib extending between the side walls is provided, so that the rigidity of the battery case itself can be improved as compared with the case where the rib is not provided. Further, at the time of a side collision of the vehicle, the side collision load input to the rocker is transmitted to the battery case side via the fastening portion. Since the fastening portion is provided on an extension line of the rib in the vehicle width direction in a plan view of the vehicle, the side protruding load transmitted to the battery case side through the fastening portion is transmitted from one side wall side to the rib, and is transmitted to the other side wall side.

### CROSS-REFERENCE TO RELATED APPLICATION

This application claims priority to Japanese Patent Application No. 2023-199426 filed on Nov. 24, 2023, incorporated herein by reference in its entirety.

### BACKGROUND

### 1. Technical Field

The disclosure relates to a battery pack structure.

### 2. Description of Related Art

In a battery electric vehicle described in CN 114940214, a battery accommodating space, which is substantially rectangular, is made up of a space portion that is defined by a pair of right and left sill beams, a front cross member, a rear cross member, and a cooling plate. A plurality of batteries is accommodated in this battery accommodating space. The sill beams may also be referred to as rockers. That is to say, the batteries are surrounded by a so-called vehicle body frame (sometimes referred to as a vehicle framework) made up of rockers, a front cross member, and a rear cross member.

### SUMMARY

However, in the above-described related art, there is concern regarding a route of conveying a side impact load input to a battery pack made up of multiple batteries, in the event of a side impact of the vehicle (hereinafter, referred to as “event of side impact of vehicle”).

In view of the above, it is an object of the disclosure to provide a battery pack structure in which a transmission path of a side impact load is secured in the event of a side impact of a vehicle.

A battery pack structure according to an aspect of the disclosure includes a battery pack body, in which battery cells are accommodated in a state of extending in a vehicle width direction and also arrayed in a vehicle front-rear direction, a first rib that protrudes extending in the vehicle width direction between the battery cells arrayed in the vehicle front-rear direction, on a bottom wall making up part of the battery pack body, and that bridges a pair of side walls extending in the vehicle front-rear direction at both ends in the vehicle width direction and making up another part of the battery pack body, and

a fastening portion that is provided on an outer side of a side wall of the battery pack body, disposed on an extension line in the vehicle width direction from the first rib in a vehicle plan view, making up part of a vehicle framework, and also fastened to a rocker extending in the vehicle front-rear direction on both outer sides in the vehicle width direction.

The battery pack structure according to the above aspect includes the battery pack body, the first rib, and the fastening portion. In the battery pack body, the battery cells are accommodated in a state in which the battery cells each extend in the vehicle width direction and are also arrayed in the vehicle front-rear direction. The first rib protrudes extending along the vehicle width direction between the battery cells arrayed in the vehicle front-rear direction, on the bottom wall making up part of the battery pack body. The first rib bridges the side walls that extend in the vehicle front-rear direction at both ends in the vehicle width direction and that make up another part of the battery pack body.

Here, the battery pack body is provided with the fastening portion on the outer side of the side wall. This fastening portion is disposed on the extension line in the vehicle width direction from the first rib in vehicle plan view, making up part of the vehicle framework, and is also fastened to the rockers extending in the vehicle front-rear direction on both outer sides in the vehicle width direction.

According to the disclosure, the first rib bridging the side walls is provided in the battery pack body, and accordingly rigidity of the battery pack body itself can be improved as compared with when the first rib is not provided. Accordingly, in the disclosure, bending deformation of the battery pack body is suppressed.

Further, in the disclosure, in the event of a side impact of the vehicle, the side impact load input to the rocker is conveyed to the battery pack body side via the fastening portion. This fastening portion is provided on the extension line in the vehicle width direction from the first rib in vehicle plan view, and accordingly the side impact load conveyed to the battery pack body side through the fastening portion is conveyed from one side wall side to the first rib, and is conveyed to the other side wall side. As described above, in the disclosure, a conveying path from one rocker side to the other rocker side is secured with respect to the side impact load.

The battery pack structure according to the above aspect further includes a second rib that is provided on the bottom wall of the battery pack and that conveys, in the vehicle width direction, a load input in the vehicle width direction, to an opposite side in the vehicle width direction.

In the above-described battery pack structure, the second rib is provided on the bottom wall of the battery pack body, and the second rib is set so as to convey, in the vehicle width direction, a load (side impact load) input in the vehicle width direction, to the opposite side in the vehicle width direction.

Thus, the second rib is provided on the bottom wall of the battery pack body, and accordingly the rigidity of the battery pack body itself can be improved as compared with when the second rib is not provided. Note that examples of the second rib provided on the bottom wall of the battery pack body include a case in which the second rib protrudes from the bottom wall of the battery pack body toward the upper side in the vehicle up-down direction, and a case in which the second rib protrudes from the bottom wall of the battery pack body toward the lower side in the vehicle up-down direction.

In the battery pack structure according to the above aspect, the second rib protrudes toward a downward side in a vehicle up-down direction, from the bottom wall of the battery pack body, and is set so as to overlap the rocker in a vehicle side view.

In the above-described battery pack structure, the second rib protrudes from the bottom wall of the battery pack body toward the lower side in the vehicle up-down direction, and is provided outside of the battery pack body. As a comparative example, when the second rib protrudes from the bottom wall of the battery pack body toward the upper side in the vehicle up-down direction, the second rib will be provided in an accommodating portion of the battery pack body. On the other hand, when the second rib protrudes from the bottom wall of the battery pack body toward the lower side in the vehicle up-down direction, the second rib will be provided outside of the battery pack body.

Accordingly, in the disclosure, the second rib protrudes from the bottom wall of the battery pack body toward the lower side in the vehicle up-down direction, so that the volume of the accommodating portion can be increased as compared with when the second rib is provided inside the accommodating portion of the battery pack body.

Also, when the second rib protrudes from the bottom wall of the battery pack body toward the lower side in the vehicle up-down direction, the second rib is set so as to overlap the rocker in vehicle side view. Thus, the side impact load can be conveyed to the opposite side in the vehicle width direction through the second rib.

Hence, according to the disclosure, the rigidity of the battery pack body can be improved while securing battery capacity.

In the battery pack structure according to the above aspect, the fastening portion is provided on a cover that closes off an accommodating portion of the battery pack body, and also, a floor that makes up a floor portion of a vehicle cabin is fashioned from the cover.

In the above-described battery pack structure, the fastening portion is provided on a cover that closes off the accommodating portion of the battery pack body. The floor that makes up the floor portion of the vehicle cabin is fashioned from the cover, and accordingly there is no need to provide a separate floor panel, and thus the number of components can be reduced.

As described above, in the battery pack structure according to the disclosure, a transmission path of the side impact load can be secured in the event of a side impact of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a configuration of a vehicle to which a battery pack structure according to the present embodiment is applied as viewed from a left obliquely upper side;

FIG. 2 is a plan view showing a state in which a part showing a configuration of a vehicle to which the battery pack structure according to the present embodiment is applied is cut away;

FIG. 3 is a schematic cross-sectional view taken along III-III line of FIG. 2;

FIG. 4 is a schematic cross-sectional view taken along IV-IV line of FIG. 2; and

FIG. 5 is a schematic cross-sectional view corresponding to FIG. 3 showing a configuration of a modification of the vehicle to which the battery pack structure according to the present embodiment is applied.

### DETAILED DESCRIPTION OF EMBODIMENTS

A battery pack structure according to an embodiment of the present disclosure will be described with reference to the drawings. Note that the arrow FR, the arrow UP, and the arrow RH shown in the drawings indicate the forward direction (traveling direction), the upward direction, and the rightward direction, respectively, of the vehicles to which the battery pack structure according to the present embodiment is applied. Hereinafter, when the description is made simply using terms indicating directions i.e., forward and rearward, right and left, and upward and downward, these means forward and rearward in the vehicle front-rear direction, right and left in the vehicle right-left direction (vehicle width direction), and upward and downward in the vehicle up-down direction unless otherwise specified. In addition, in the drawings, some members and some reference numerals may be omitted from the drawings in order to make the drawings easy to see.

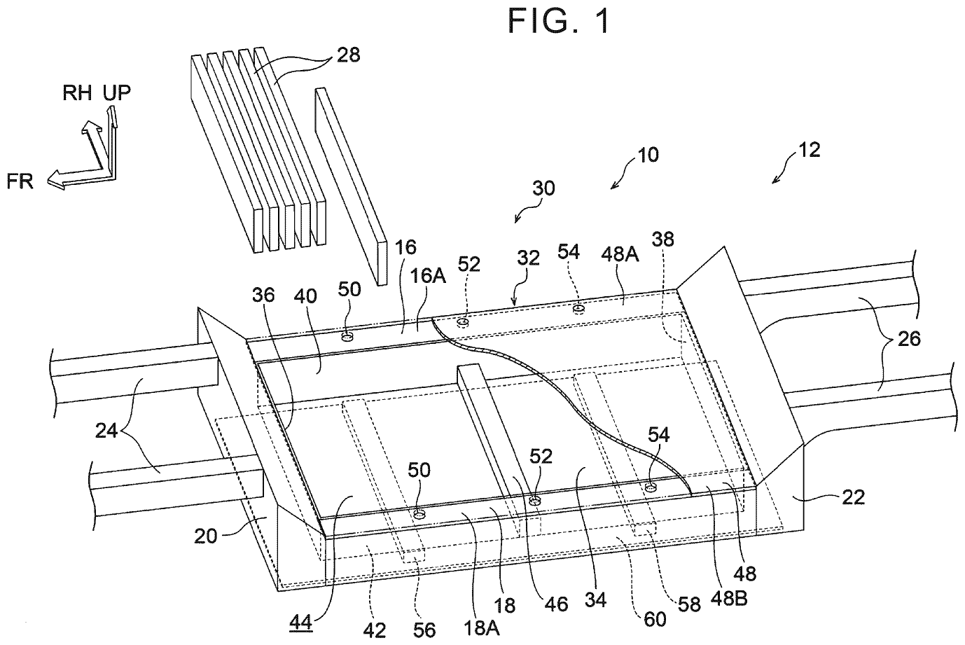

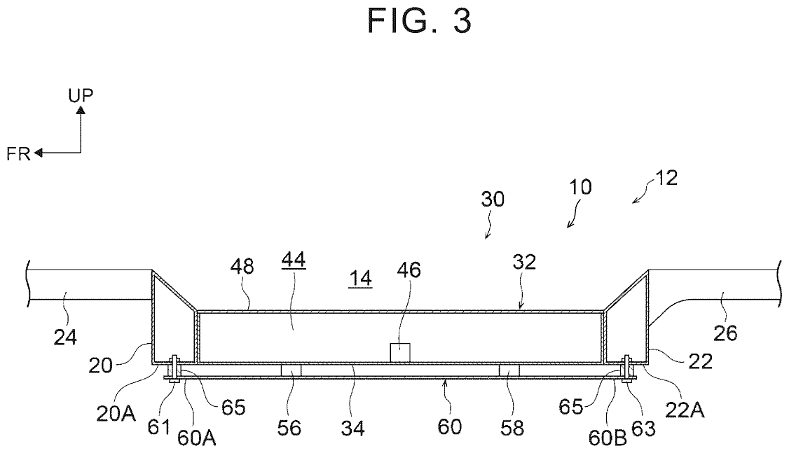

As shown in FIG. 1, a vehicle (vehicle body) 12 to which the battery pack structure 10 according to the embodiment of the present disclosure is applied includes a pair of left and right rockers 16 and 18, a front cross member 20, and a rear cross member 22. Each of the pair of left and right rockers 16 and 18 constitutes a vehicle framework and extends along the vehicle front-rear direction at both end portions in the vehicle width direction of the vehicle cabin 14 (see FIG. 3). The front cross member 20 is provided along the vehicle width direction at the front ends of the rockers 16 and 18. The rear cross member 22 is provided along the vehicle width direction at the rear ends of the left and right rockers 16 and 18. A front side member 24 extends along the vehicle front-rear direction on both end sides in the vehicle width direction of the front cross member 20. A rear side member 26 extends along the vehicle front-rear direction on both end sides of the rear cross member 22 in the vehicle width direction.

The vehicle 12 according to the present embodiment is a battery electric vehicle traveling by using a driving force of an electric motor (not shown). A battery pack (battery pack body) 30 in which a plurality of battery cells 28 for supplying electric power for driving the electric motor are accommodated is provided in a lower portion of the vehicle 12.

### Configuration of Battery Pack Structure

Here, the configuration of the battery pack structure according to the present embodiment will be described.

As illustrated in FIG. 1, a battery pack structure 10 according to the present embodiment includes a battery pack 30. The battery pack 30 is made of, for example, a light metal such as an aluminum alloy, and includes a box-shaped battery case (battery pack body) 32 having a rectangular shape with a longitudinal direction of the vehicle in a plan view and having an upper side as an opening. In addition, a resin member such as a carbon-fiber-reinforced plastic (CFRP) or a glass-fiber-reinforced plastic (GFRP) may be used in addition to the metal. The same applies to the cover 48 and the under cover 60 described later.

The battery case 32 includes a bottom wall 34, a front wall 36, a rear wall 38, and a pair of side walls 40 and 42. The front wall 36 is erected from the front end of the bottom wall 34 in the vehicle front-rear direction. The rear wall 38 faces the front wall 36 and stands from the rear end of the bottom wall 34 in the vehicle front-rear direction. The pair of side walls 40 and 42 are erected and opposed to each other from both ends of the bottom wall 34 in the vehicle width direction.

In the present embodiment, for example, the separation distance between the front wall 36 and the rear wall 38 of the battery case 32 is formed to be slightly narrower than the separation distance between the front cross member 20 and the rear cross member 22. Further, the separation distance between the side wall 40 and the side wall 42 of the battery case 32 is formed to be slightly narrower than the separation distance between the rocker 16 and the rocker 18. Accordingly, the battery case 32 according to the present embodiment can be arranged in a space surrounded by the rockers 16 and 18, the front cross member 20, and the rear cross member 22 constituting the vehicle framework.

Further, a plurality of thin plate-shaped battery cells 28 having a substantially rectangular shape with the vehicle width direction as a longitudinal direction are accommodated in the accommodating portion 44 of the battery case 32 including the bottom wall 34, the front wall 36, the rear wall 38, and the side walls 40 and 42. The battery cells 28 are arranged along the vehicle front-rear direction. Here, the accommodating portion 44 is configured as one space, but the accommodating portion 44 may be partitioned into a plurality of spaces.

On the other hand, at substantially the center of the bottom wall 34 of the battery case 32 in the vehicle front-rear direction, a rib (first rib) 46 is protruded along the vehicle width direction between the battery cells 28 adjacent to each other in the front-rear direction, and the rib 46 is bridged between the side wall 40 and the side wall 42. Here, for example, the height of the rib 46 is set to be about half of the side wall 40, and the dimension in the height direction is set to be larger than the dimension in the vehicle front-rear direction, but the present disclosure is not limited thereto (described later).

The accommodating portion 44 of the battery case 32 is closed by a cover 48 having a rectangular plate shape in a plan view in a state in which the plurality of battery cells 28 are accommodated. The cover 48 is made of, for example, a light metal such as an aluminum alloy, and has a plate shape in which the vertical direction of the vehicle is a plate thickness direction, and is integrated with the battery case 32 by welding or the like.

Both end portions 48A, 48B of the cover 48 in the vehicle width direction protrude outward in the vehicle width direction from the side walls 40 and 42 of the battery case 32. Further, both end portions 48A, 48B of the cover 48 can be fastened to the upper wall 16A, 18A of the rockers 16 and 18, for example, via fastening portions 50, 52, and 54 arranged along the front-rear direction of the vehicle. The fastening methods of the fastening portions 50, 52, and 54 include bolt fastening, riveting, spot welding, and the like. It is possible to change as appropriate depending on the material to be fastened.

Here, in the present embodiment, the fastening portion 52 is provided on an extension line of the rib 46 in the vehicle width direction in a plan view of the vehicle. In the present embodiment, the fastening portions 50, 52, and 54 provided on both end portions 48A, 48B of the cover 48 in the vehicle width direction are continuously formed along the vehicle front-rear direction, but the fastening portions 50, 52, and 54 may be intermittently formed.

On the other hand, the ribs (second ribs) 56 and 58 protrude from the bottom wall 34 of the battery case 32 along the vehicle width direction. A plurality of the ribs 56 and 58 are arranged along the vehicle front-rear direction. In the present embodiment, the rib 56 is provided on the front side of the rib 46 in plan view, and the rib 58 is provided on the rear side of the rib 46.

The lower side of the ribs 56 and 58 is provided with an under cover 60 disposed substantially parallel to the bottom wall 34 of the battery case 32. The under cover 60 is made of, for example, a light metal such as an aluminum alloy, and has a plate shape in which the vehicle vertical direction is a plate thickness direction, and has a role of preventing interference with a road surface.

As shown in FIG. 3, the front end portion 60A of the under cover 60 is fastened to the lower wall 20A of the front cross member 20 via the fastening portion 61. The rear end portion 60B of the under cover 60 is fastened to the lower wall 22A of the rear cross member 22 via the fastening portion 63. As the fastening methods of the fastening portions 61 and 63, the fastening portions 50, 52, and 54 may be, for example, rivet fastening, spot welding, or the like, in addition to bolt fastening. Further, in the fastening portions 61 and 63, spacers 65 are provided in order to maintain a gap between the bottom wall 34 of the battery case 32 and the under cover 60.

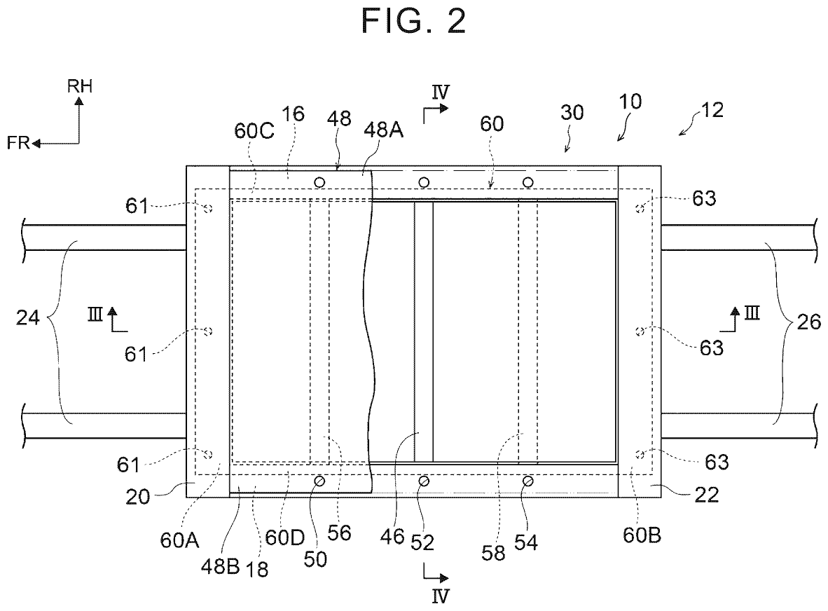

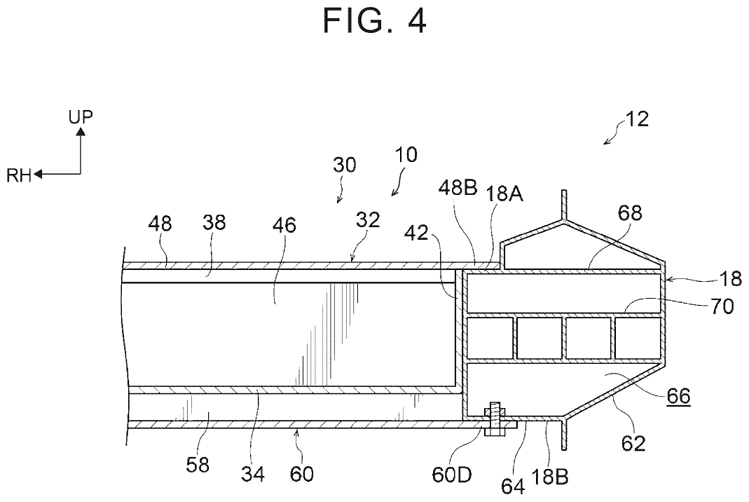

As shown in FIG. 2, both end portions 60C, 60D of the under cover 60 in the vehicle width direction are fastened to the lower wall 18B (see FIG. 4) of the rocker 18, and the ribs 56 and 58 are disposed between the rocker 16 and the rocker 18. The rocker 16 and the rocker 18 have substantially the same configuration. Therefore, in FIG. 4, only the rocker 18 side is shown as a representative of both.

As shown in FIG. 4, the height of the rib 46 is set to be slightly lower than the side wall 42. As described above, by increasing the height of the rib 46, for example, the inside of the rib 46 is formed in a hollow shape, and a cooling pipe in which a cooling medium for cooling the battery cells 28 flows can be arranged in the hollow. In addition, in this case, wiring such as a cable and a harness may be arranged in addition to the cooling pipe.

On the other hand, the rocker 18 has a closed cross-sectional structure including a closed section portion 66 formed by an outer portion 62 and an inner portion 64. An EA portion (shock absorbing portion) 68 formed in a straight line extending between the outer portion 62 and the inner portion 64 and an EA portion 70 formed in a ladder shape are provided in the closed section portion 66. As described above, by providing EA portions 68 and 70 in the closed section portion 66 of the rocker 18, the side-collision load inputted during the side-collision of the vehicles can be absorbed by the plastic deformation of EA portions 68 and 70. EA portion 70 is set so as to overlap with the rib 46 in a vehicle-side view.

Further, an end portion in the vehicle width direction of the cover 48 is fastened to the upper wall 18A of the inner portion 64 of the rocker 18, and both end portions 60C, 60D in the vehicle width direction of the under cover 60 (see FIG. 2) are fastened to the lower wall 18B of the inner portion 64. Note that the configuration and the shape of the rocker 18 are merely examples, and are not limited to the configuration and the shape.

### Operation and Effects of Battery Pack Structure

Next, the operation and effects of the battery pack structure according to the present embodiment will be described.

As illustrated in FIGS. 1 and 2, in the present embodiment, the battery pack structure 10 includes a battery case 32, a rib 46, and a fastening portion 52. In the battery case 32, the battery cells 28 are accommodated in a state of being extended along the vehicle width direction and being arranged along the vehicle front-rear direction. The rib 46 protrudes along the vehicle width direction between the battery cells 28 arranged along the vehicle front-rear direction in the bottom wall 34 of the battery case 32, and extends between the side walls 40 and 42 of the battery case 32.

As described above, in the present embodiment, since the rib 46 extending between the side walls 40 and 42 is provided in the battery case 32, the rigidity of the battery case 32 itself can be improved as compared with the case where the rib 46 is not provided. Thus, in the present embodiment, the bending deformation of the battery case 32 is suppressed.

Further, in the present embodiment, a fastening portion 52 between the cover 48 and the rockers 16 and 18 is provided on an extension line of the rib 46 in the vehicle width direction in a plan view of the vehicle. Therefore, in the present embodiment, at the time of side collision of the vehicle 12, the side collision load input to the rocker 18 is transmitted to the battery case 32 side via the fastening portion 52. Since the fastening portion 52 is provided on the extension line of the rib 46 in the vehicle width direction in a plan view of the vehicle, the side protruding load transmitted to the battery case 32 side through the fastening portion 52 is transmitted from one side wall 42 side to the rib 46, and is transmitted to the other side wall 40 side.

As described above, in the present embodiment, the transmission path from one rocker 18 side to the other rocker 16 side is secured with respect to the side collision load. Further, by providing the fastening portion 52 between the cover 48 and the rockers 16 and 18 on the extension line of the rib 46 in the vehicle width direction in a plan view of the vehicle, the effect of positioning the fastening portion 52 is also obtained.

Further, the rib 46 is set so as to overlap EA portion 70 provided in the closed section portion 66 of the rocker 18 shown in FIG. 4 when viewed from the side of the vehicle. Therefore, the side collision load inputted at the time of the side collision of the vehicle can be reliably transmitted to the rib 46 side via EA portion 70.

Further, in the present embodiment, as shown in FIG. 3, ribs 56 and 58 are provided on the bottom wall 34 of the battery case 32, and the ribs 56 and 58 are set so as to transmit the side collision load along the vehicle width direction with respect to the opposite side in the vehicle width direction. As described above, since the ribs 56 and 58 are provided on the bottom wall 34 of the battery case 32, the rigidity of the battery case 32 itself can be improved as compared with the case where the ribs 56 and 58 are not provided. Further, in the present embodiment, by providing the plurality of ribs 56 and 58, it is possible to distribute the side collision load.

Incidentally, as the ribs 56 and 58 provided on the bottom wall 34 of the battery case 32, there are a case where the ribs 56 and 58 project from the bottom wall 34 of the battery case 32 toward the vehicle upper side, and a case where the ribs project from the bottom wall 34 of the battery case 32 toward the vehicle lower side.

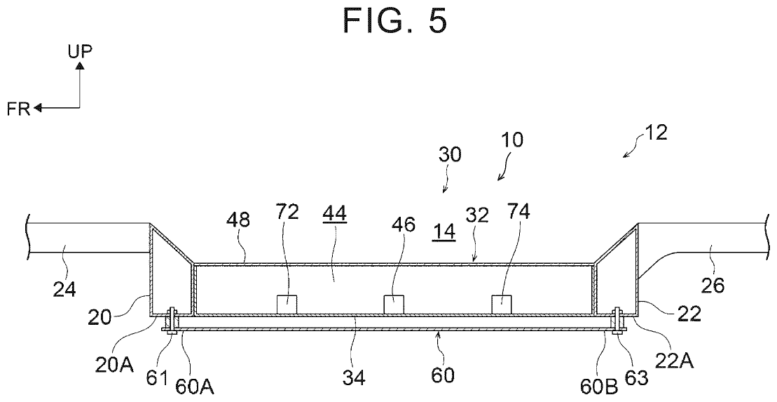

For example, as a comparative example, as shown in FIG. 5, when the ribs 72 and 74 protrude from the bottom wall 34 of the battery case 32 toward the vehicle upper side, the ribs 72 and 74 are provided in the battery case 32. Therefore, the ribs 72 and 74 together with the rib 46 are provided between the pair of side walls 40 and 42 of the battery case 32. This makes it possible to further improve the rigidity of the battery case 32 itself.

On the other hand, in the present embodiment, as shown in FIG. 3, the ribs 56 and 58 protrude from the bottom wall 34 of the battery case 32 toward the vehicle lower side. In this case, the ribs 56 and 58 are provided outside the battery case 32. In the present embodiment, as shown in FIG. 4, the ribs 56 and 58 are set so as to overlap the rockers 16 and 18 in a vehicle side view. Therefore, the ribs 56 and 58 allow the load input along the vehicle width direction to be transmitted along the vehicle width direction to the opposite side in the vehicle width direction.

Here, in the present embodiment, as shown in FIG. 3, the ribs 56 and 58 protrude from the bottom wall 34 of the battery case 32 toward the vehicle lower side. Therefore, the volume in the accommodating portion 44 can be increased as compared with the case where the ribs 72 and 74 (see FIG. 5) are provided in the accommodating portion 44 of the battery case 32.

Therefore, in the present embodiment, it is possible to improve the rigidity of the battery case 32 while ensuring the battery capacity. However, as shown in FIG. 5, the present disclosure also includes a configuration in which the ribs 72 and 74 protrude from the bottom wall 34 of the battery case 32 toward the vehicle upper side.

Incidentally, in the present embodiment, the fastening portion 52 is provided in the cover 48 that closes the accommodating portion 44 of the battery case 32. The cover 48 constitutes a floor. Thus, in the present embodiment, for example, although not shown as a comparative example, as compared with a case where a separate floor panel is provided on the upper side of the cover 48, it is possible to reduce the number of parts, work man-hours are also reduced.

### ADDITIONAL REMARKS

Note that the battery pack structure according to the present disclosure may be formed by appropriately combining the following configurations.

### Configuration 1

In the battery pack structure, a battery pack body is accommodated in a state in which the battery cells are extended along the vehicle width direction and are arranged along the vehicle front-rear direction, and a bottom wall constituting a part of the battery pack body, the battery pack body is provided with a first rib extending along the vehicle width direction between the battery cells arranged along the vehicle front-rear direction and extending along the vehicle front-rear direction at both ends in the vehicle width direction and a first rib extending between a pair of side walls constituting the other part of the battery pack body and extending along the vehicle front-rear direction at both ends in the vehicle width direction, and a fastening portion provided outside the side wall of the battery pack body and arranged on an extension line in the vehicle width direction of the first rib in a vehicle plan view and configured to constitute a part of the vehicle framework and fastened to a rocker extending along the vehicle front-rear direction on both sides in the vehicle width direction.

### Configuration 2

The battery pack body further includes a second rib provided on a bottom wall of the battery pack body and configured to transmit a load input along the vehicle width direction to a side opposite to the vehicle width direction along the vehicle width direction.

### Configuration 3

the second rib protrudes toward a downward side in a vehicle up-down direction, from the bottom wall of the battery pack body, and is set so as to overlap the rocker in a vehicle side view.

### Configuration 4

The fastening portion is provided on a cover that closes an accommodating portion of the battery pack body, and a floor that constitutes a floor portion in a vehicle cabin is configured by the cover.

In addition, the present disclosure can be implemented with various modifications without departing from the scope of the disclosure. Further, it goes without saying that the scope of rights of the present disclosure is not limited to the above-described embodiment.

What is claimed is:

1. A battery pack structure, comprising:
a battery pack body, in which battery cells are accommodated in a state of extending in a vehicle width direction and also arrayed in a vehicle front-rear direction;
a first rib that protrudes extending in the vehicle width direction between the battery cells arrayed in the vehicle front-rear direction, on a bottom wall making up part of the battery pack body, and that bridges a pair of side walls extending in the vehicle front-rear direction at both ends in the vehicle width direction and making up another part of the battery pack body; and
a fastening portion that is provided on an outer side of a side wall of the battery pack body, disposed on an extension line in the vehicle width direction from the first rib in a vehicle plan view, making up part of a vehicle framework, and also fastened to a rocker extending in the vehicle front-rear direction on both outer sides in the vehicle width direction.

2. The battery pack structure according to claim 1, further comprising a second rib that is provided on the bottom wall of the battery pack body and that conveys, in the vehicle width direction, a load input in the vehicle width direction, to an opposite side in the vehicle width direction.

3. The battery pack structure according to claim 2, wherein the second rib protrudes toward a downward side in a vehicle up-down direction, from the bottom wall of the battery pack body, and is set so as to overlap the rocker in a vehicle side view.

4. The battery pack structure according to claim 1, wherein the fastening portion is provided on a cover that closes off an accommodating portion of the battery pack body, and also, a floor that makes up a floor portion of a vehicle cabin is fashioned from the cover.
